(19) United States
(12) Patent Application Publication
(10) Pub. No.: US 2009/0008189 A1
(43) Pub. Date: Jan. 8, 2009

(54) Lubrication system

(76) Inventor: Gregory J. Prodan, Phoenix, AZ (US)

Correspondence Address: TOD R NISSLE, PO BOX 55630, PHOENIX, AZ, 85078, US

(21) Appl. No.: 11/825,024

(22) Filed: Jul. 3, 2007

(51) Int. Cl. F16N 7/00

(52) U.S. Cl. 184/6

(57) ABSTRACT

A lubrication system utilizes an increase in ambient air pressure to dispense oil through a tubing. The tubing inner diameter and length, along with coils formed in the tubing, are selected to prevent blockage of the tubing and to dispense gradually over an extended period of time small amounts of oil.

This invention relates to lubrication systems.

More particularly, the invention relates to a system for periodically administering to a bearing or other mechanical component(s) oil or another lubricating liquid.

In a further respect, the invention relates to a system to utilize an increase in ambient air temperature to expand air and oil in a container to administer under pressure the oil from the container through a tubing to a bearing or other pre-existing mechanical component.

One problem with administering oil periodically under pressure through a tube is that if the inner diameter of the tube is too small, the end of the tube can become blocked by dirt particles or other matter, preventing oil from moving through the tube. This is particularly the case in situations where the pressure applied to the oil lessens to a point where oil tends to be drawn back into the tube.

Another problem of administering periodically oil under pressure through a tube from a reservoir is that when the pressure generated against oil in the reservoir dissipates, oil can back flow through the tube into the reservoir. This increases the likelihood that material will be drawn into the tube and block the tube or contaminate the reservoir. It also means that when sufficient pressure is reestablished, oil must move from the reservoir along the length of the tube.

A further problem of administering oil under pressure through a tube is that if the pressure becomes sufficiently great an unnecessarily large quantity of oil can be discharged.

Still another problem of administering oil under pressure through a tube is that the oil can be rapidly depleted, even at relatively low temperatures, requiring the reservoir to be recharged with oil on a frequent basis.

Yet a further problem of administering oil under pressure through a tube is that if the pressure generated against the oil is relatively modest, oil must still be capable of being administered through the tube while at the same time minimizing the likelihood that the tube will become blocked.

Accordingly, it would be highly desirable to provide an improved lubricant administering system of the type described that would minimize the likelihood that a tube will become blocked, will administer oil with relatively small pressure increases acting on the oil, and will administer small quantities of oil over a long period of time without requiring additional oil to recharge the system.

Therefore, it is a principal object of the instant invention to provide an improved oil administration system of the type including a pressurized reservoir and a tube leading from the reservoir to a bearing or other selected oil administering location.

A further object of the invention is to provide an improved oil administration system of the type described that minimizes the amount of oil that back flows toward the reservoir when the pressure in the reservoir decreases.

Another object of the invention is to provide an improved oil administration system of the type described that generally prevents excessive amounts of oil from being delivered by the system.

This and other, further and more specific objects of the invention will be apparent from the following detailed description thereof, taken in conjunction with the drawings, in which:

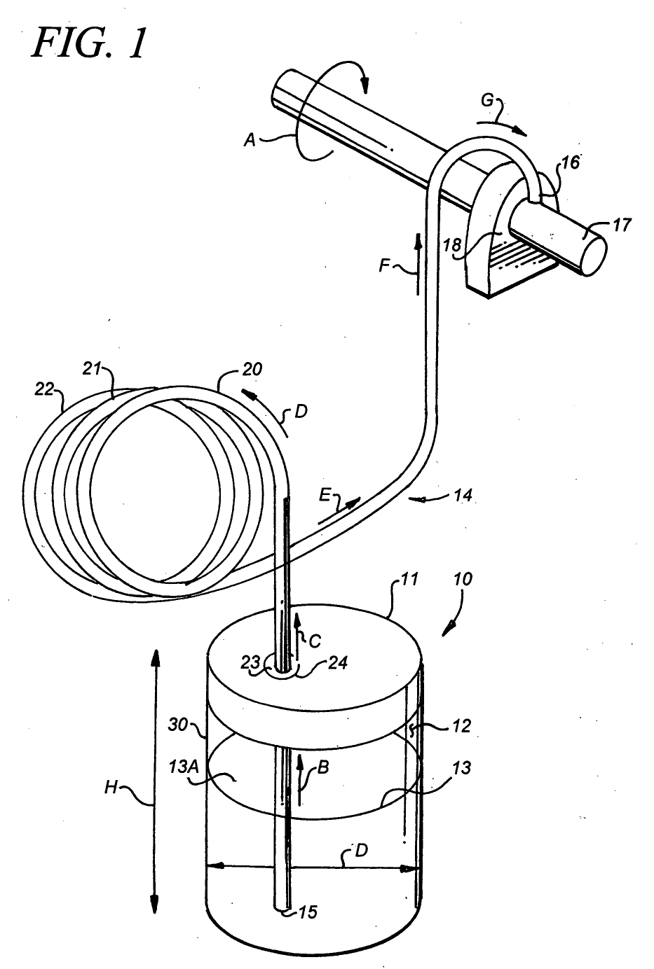

FIG. 1 is a perspective view illustrating an oil administration system constructed in accordance with the principles of the invention; and,

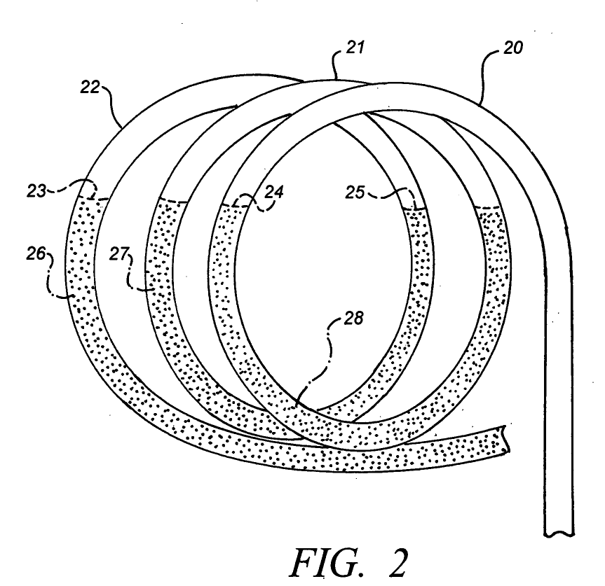

FIG. 2 is a front view illustrating the mode of operation of the coils in the apparatus of the invention.

Briefly, in accordance with the invention, I provide an improved method to dispense oil at a mechanical device over an extended period of time. The method includes the steps of providing a container; partially filing the container with oil; providing tubing having an ID in the range of 0.003 inch to 0.008 inch, a first end, a second end, and a coiled section intermediate said ends; inserting the first end in the oil in the container; sealing the container at a selected ambient temperature; placing the container at a selected location;

placing the second end at the mechanical device; and, allowing the ambient temperature to increase above the selected ambient temperature to increase air pressure in the sealed container and dispense oil from the container, into and through the tubing, out the second end, and onto the mechanical device.

Turning now to the drawings, which depict the presently preferred embodiments of the invention by way of explanation, and not limitation, and in which like reference characters refer to corresponding elements throughout the several views, FIG. 1 illustrates an oil lubrication system constructed in accordance with the invention and including a sealed oil supply 10 including an open-mouthed cylindrical container 30 with a lid 11 sealingly turned onto the top of container 30. Lid 24 includes an aperture 24 formed therethrough. A bushing 23 is sealingly mounted in aperture 24. Tube 14 extends through bushing. Bushing 23 sealingly engages a portion of the exterior surface of tube 14. A reservoir 13 of oil or another liquid lubricant is inside container 30 and occupies in the bottom portion of the inner volume of container 30. Air 12 or another gas is inside container 30 and occupies the upper portion of the inner volume of container 30. One end 15 of tube 14 is submerged in reservoir 13. The other end 16 of tube 14 is located at a selected location adjacent a bearing 18, rotating shaft 17, or other desired mechanical component that requires lubrication. Shaft 17 rotates in bearing 18 in the direction indicated by arrow A. One or more coils 20, 21, 22 are formed in tubing 14 intermediate oil supply 10 and end 16.

### Volume of Air

The system of the invention relies on increases in ambient temperature and/or on sunlight impinging on container 30 to heat air 12 inside sealed supply 10 and to heat oil in reservoir 13. When the temperature of the ambient air 12 increases, the pressure generated against reservoir 13 by air 12 increases. This pressure acts on the oil 13 and causes oil to travel from supply 10 and through tubing 14. If the volume of air is too small, insufficient pressure is generated. Consequently, the volume of air in container is at least n cubic inches (for example, an air space that is one inch high in a container that is eight inches high and has a one inch radius), is preferably at least 6π cubic inches (for example, an air space that is two inches high in a container that is eight inches high and has a one inch radius), and is most preferably at least 18π cubic inches (for example, an air space that is three inches high in a container that is eight inches high and has a one inch radius). In addition, the volume of the air space in a container 30 is at least ten percent of the entire inner volume of container 30, is preferably at least twenty percent of the entire inner volume of container 30, and is most preferably at least thirty percent of the entire inner volume of container 30.

### Surface Area

If the diameter D (or width) of the container 30 is too small, then the upper surface area 13A of oil at the oil-air interface is small, and a relatively small increase in air pressure can possibly exert a significant amount of lbs/inch pressure on the upper surface area 13A and cause oil to be dispensed from end 16 at a greater rate than is desired. A smaller diameter tube 14 can be utilized to blunt the effect of such an increased pressure, but then the end 16 is more likely to be blocked or plugged by particles of dirt or other material. Consequently, in the practice of the invention, the upper surface area 13A of the oil 13 is at least π (pi) square inches (for example, in a cylindrical container having a one inch radius), preferably 4π square inches (for example, in a container having a two inch radius), and more preferably at least 9π square inches (for example, in a container having a three inch radius). The shape of container 30 can vary as desired, but a cylindrical shape is preferred. The size of container 30 can also vary as desired, but the presently preferred container is a quart sized container, has a three inch inner diameter, indicated by arrow D in the drawing, and a five inch height, indicated by arrow H in FIG. 1.

### Inner Diameter (ID) of Tubing 14

If the ID (inner diameter) of tubing 14 is too great, the quantity of oil dispensed from supply 10 can be excessive, resulting in the early dissipation of oil 13 and requiring frequent replenishing of the oil supply. An overly large tubing inner can also facilitate excessive amounts of air being drawn into tubing 14 and make it more difficult for oil to travel from container 30 along the length of tubing 14 to the end of tubing. One object of the invention is to produce an lubrication system in which the oil supply 10 will last for an extended period of time, preferably a year or more. Alternatively, if the ID of tubing 14 is too small, the tubing is more likely to become blocked, and to require excessive pressure to move oil through the tubing 14. Consequently, in experimenting with the volume of air, surface area of oil at the air-oil interface, size of coils, and various other configurations and apparatus to develop the parameters necessary for the invention to function, it was determined that the acceptable ID of tubing 14 is in a substantially narrow range of 0.003 to 0.008 inch, preferably 0.004 to 0.006 inch.

### Coils

When the ambient temperature increases from the normal temperature, say seventy-six degrees F., at which the supply 10 was assembled, the air pressure in container 30 increases and acts to move oil from container 30 into and along tubing 14 to end 16 in the manner indicated by arrows B, C, D, E, F in FIG. 1. When, however, the ambient temperature decreases, possibly to a level even less than normal ambient temperature of seventy-six degrees F., then the pressure in container 30 decreases and tends to draw oil away from end 16, along tubing 14 and back into container 30. This phenomenon can tend to draw dirt particles and other unwanted substances into tubing. Coils 20, 21, 22 are important in the practice of the invention and are believed to minimize this problem because if the coils are utilized in the vertical orientation shown in FIG. 1 in a tubing having an ID in the range of 0.003 to 0.008, the coils function as an intermediate oil storage area, or sink. When oil attempts to move upwardly through a coil 20 to 22 and away from the ground, the gravitational force acting on the oil works to prevent the oil from traveling up one side a each coil and away from the ground so that after the ambient temperature returns to normal, and the air pressure in container 30 is reduced, some oil remains in coils 20 to 22. This facilitates the dispensing of oil from end 16 when the ambient temperature again begins to rise. FIG. 2 illustrates oil remaining in coils 20 to 22 after the ambient temperature returns to a normal temperature, or to a temperature lower than normal, and pressure acting on oil 13 dissipates. Dashed lines 23 to 25 indicate the upper surfaces of oil in coils 20 to 22, and, assuming that some air is drawn into tubing 14 when the ambient temperature decreases, stippling 26 to 28 indicates oil remaining in coils 20 to 22 after the pressure acting on oil 13 dissipates from the maximum pressure generated during the day (or other period of time).

The diameter of each coil 20 to 22 can vary, but is presently in the range of one to twelves inches, preferably three to four inches. If the diameter of the coils is too small, their oil storage capacity is limited. If the coils are too large, they require too much space and also store an excessive amount of oil. Further, if the coils are too large, the length of tubing 14 increases, which increases the frictional resistance generated by tubing 14 when oil 13 is moving through the tubing 14. The presently preferred length of tubing 14 is four to fifteen feet, preferably five to ten feet. When the length of the tubing 14 exceeds ten to fifteen feet, then the frictional resistance generated by the tubing can prevent oil from readily reaching end 16 when the ambient temperature increases. Conversely, if the length of the tubing 14 is less than four to five feet, and end 15 is positioned below end 16, coils 20, 21, 22 may not prevent most of the oil in tubing 14 from returning to reservoir 30 when the ambient temperature decreases. As the length of tubing 14 decreases, the frictional resistance and surface tension effects generated by tubing 14 decrease. Coils 20 to 22 also function to increase the length of tubing 14 to increase the cumulative frictional resistance acting along the interior length of tubing 14 to slow the movement of oil therealong.

The coil(s) 20 to 22 formed in tubing 14 perform another important function. The frictional resistance provided by the coils tend to slow the dispensing of oil from container 30. Coil(s) 20 to 22 therefore tend to function like a valve, or metering device.

### Vertical Displacement

One virtue of the invention is that end 15 can be at a lower elevation than end 16.

This can be advantageous if it is desired to lubricate a bearing in a roof-mounted evaporative cooler or other air conditioning unit.

### Vacuum Buildup

As the amount of oil in container 30 decreases, the volume of the space above the oil 13 increases. This means that a greater increase in ambient temperature is necessary to generate the pressure necessary to force oil through tubing 14 and out end 16. This typically is a minor problem for at least two reasons. First, the length and ID of tubing 14, are adjusted such that oil is dispensed from end 16 at a low rate. Six-tenths of a quart of oil in a one quart container 30 typically will take at least several years to be dispensed. Consequently, oil is dispensed on average from container 30 at a preferred rate in the range of 0.25 milliliter to 0.75 milliliter per day. Consequently, the formation of a vacuum on container 30, would occur at a slow rate. Second, bushing 23 or another valve structure in container 13 or lid 11 can, if desired, can be configured to prevent air from escaping from container 30 and can, at the same time, permit air to gradually enter container to return the air 12 in container 30 to atmospheric pressure in the event an excessive vacuum begins to form in container 30. Third, when the air in the container cools, small amounts of air make their way through tubing 14 and back into container 30 and tend to stabilize the air pressure in container 30, offsetting the possible formation of a vacuum in container 30.

As would be appreciated by those of skill in the art, more than one length of tubing 14 can be directed into container 30 by forming another aperture in lid 11, inserting another bushing in the second aperture, and inserting the end of a second length of tubing through the bushing and into oil 13.

In use, a desired portion of container 30 is filled with oil and lid 11 is sealingly secured to container 30 at a selected ambient temperature. Tubing 14 is, in accordance with the parameters discussed above, selected having a desired length, coil diameter, and ID to permit oil to be dispensed from free unsealed end 16 at a desired rate at a selected pressure. One end portion of tubing 14 is slidably sealingly inserted through bushing 23 such that end 15 is submersed in oil 13 and such that a remaining portion of tubing 14 extends outwardly away from container 30 and free unsealed end 16 is spaced away from container 30. Container 30 is placed at a desired location, typically near a bearing or other desired mechanical device. Tubing 14 is manipulated to position free end 16 at a desired location adjacent the bearing or other pre-existing mechanical device to dispense oil onto the bearing 18, rotating shaft 17, or other mechanical device. If necessary, brackets or other fasteners can be utilized to secure container 30 and tubing 14 such that container 30, tubing 14, and free end 16 remain in a desired position or configuration. Container 30 is placed in a position such that end 15 is at the same elevation as end 16, is below end 16, or is above end 16, as desired. Coils 20 to 22 can be horizontally oriented, but are preferably in the upright vertical orientation illustrated in FIG. 1. When the ambient temperature rises a selected amount, the air and oil in container 30 are heated, and pressure generated in container 30 causes oil to be discharged from free unsealed end 16. When the temperature returns to ambient, or falls an amount sufficient to cool the air and oil in container 30 so that sufficient pressure is no longer generated in container 30 to dispense oil from end 16, then oil is not discharged from end 16 until the ambient temperature again rises an amount sufficient to heat the air and oil in container 30 to generate a pressure in container sufficient to dispense oil from end 16. Currently, a daytime ambient temperature that is in the range of twenty to fifty degrees F., preferably in the range of ten to forty degrees F., greater than the low nighttime ambient temperature is sufficient to cause oil to be dispensed from end 16.

The viscosity of the oil also affects the rate at which oil is dispensed from end 16. Currently, thirty weight oil is preferred, although any desired viscosity of oil can be utilized. Consequently, since the viscosity of oil can significantly increase at temperatures near or below freezing, the apparatus of the invention normally is not intended to function at such temperatures, but is instead intended to function when the daytime ambient temperature is fifty degrees or more.

In the currently preferred embodiment of the invention, the ID of tubing 14 is 0.005 inch, the length of tubing 14 is ten feet, the diameter of coils 20 to 22 is about four inches, cylindrical container 30 has a diameter of three inches and a height of five inches, container is initially 60% filled with oil and 40% filled with air, container 30 is positioned such that end 16 is about level with end 14, oil is dispensed from end 16 at an average rate in the range of 0.25 ml to 0.75 ml per day in Phoenix, Ariz., at a daytime ambient temperature in Phoenix during the year that typically ranges between about forty degrees F. and one hundred and fifteen degrees F., thirty weight oil is utilized in container 30, and, the ambient temperature typically must rise at least ten degrees F. from the lowest night time ambient before oil is dispensed from end 16.

As used herein, the term oil includes oil and other liquid lubricants produced from natural sources and includes synthetically produced liquid lubricants.

Having described the presently preferred embodiments and best mode of the invention in such terms as to enable those of skill in the art to understand and practice the invention, I claim:

1. A method to dispense, at ambient temperatures of fifty degrees F. or greater, oil at a pre-existing mechanical device over an extended period of time, including the steps of
(a) providing a container having an inner volume and separate from the pre-existing mechanical device;
(b) partially filing said inner volume of said container with oil, the remainder of said inner volume being filled with air;
(c) providing at least one tubing having a length in the range of four to fifteen feet, an ID in the range of 0.003 inch to 0.008 inch, a first end, a second unsealed free end, and a coiled oil-metering section intermediate said ends,
(d) inserting said first end in said oil in said container such that said second unsealed free end is positioned outside of said container;
(e) sealing said container at a selected ambient temperature;
(f) placing said container at a selected location such that said tubing can be manipulated to extend from said container to a desired location adjacent said mechanical device;
(g) manipulating and positioning said tubing to position said second free unsealed end at said desired location without sealing said second end; and
(h) allowing said ambient temperature to increase
(i) above said selected ambient temperature, and
(ii) to a temperature of fifty degrees or more,
to heat air and oil in said container and increase air pressure in said sealed container and dispense oil from said container, through said tubing, out said second free unsealed end, and onto said pre-existing mechanical device.
